(19) United States
(12) Patent Application Publication
(10) Pub. No.: US 2026/0171535 A1
(43) Pub. Date: Jun. 18, 2026

(54) ELECTRODE ASSEMBLY

(71) Applicant: TOYOTA JIDOSHA KABUSHIKI KAISHA, Toyota-shi (JP)

(72) Inventors: Mitsuru TATEISHI, Toyota-shi (JP); Masashi UEDA, Toyota-shi (JP); Jun IZUMI, Toyota-shi (JP); Shizuka MASUOKA, Nagoya-shi (JP); Aya SATO, Nagoya-shi (JP); Yuji KATAYAMA, Okazaki-shi (JP); Tatsuya YAMAMOTO, Toyohashi-shi (JP); Keitaro MACHIDA, Hamamatsu-shi (JP)

(73) Assignee: TOYOTA JIDOSHA KABUSHIKI KAISHA, Toyota-shi (JP)

(21) Appl. No.: 19/391,809

(22) Filed: Nov. 17, 2025

(30) Foreign Application Priority Data
Dec. 13, 2024 (JP) 2024-218929

(51) Int. Cl. H01M 10/653; H01M 4/70; H01M 10/0587

(52) U.S. Cl. CPC H01M 10/653; H01M 4/70; H01M 10/0587

(57) ABSTRACT

A first electrode sheet includes a first portion located on an outermost side and serving as one turn around a winding axis, a second portion located inward of the first portion and serving as one turn around the winding axis, and a third portion located inward of the second portion and serving as one turn around the winding axis. Multiple holes includes a first hole provided in the first portion, a second hole provided in the second portion, and a third hole provided in the third portion. The second hole is located away from a first facing portion of the second portion that faces the first hole in a direction perpendicular to a surface of the first portion. The third hole is located away from a second facing portion of the third portion that faces the second hole in a direction perpendicular to a surface of the second portion.

### CROSS-REFERENCE TO RELATED APPLICATION

This application claims priority to Japanese Patent Application No. 2024-218929 filed on Dec. 13, 2024. The disclosure of the above-identified application, including the specification, drawings, and claims, is incorporated by reference herein in its entirety.

### BACKGROUND

### 1. Technical Field

The present disclosure relates to an electrode assembly.

### 2. Description of Related Art

Japanese Unexamined Patent Application Publication No. 2019-96592 (JP 2019-96592 A) discloses an electrode body (electrode assembly) including an insulating base (insulating film) and conductive layers (conductive films) provided on two surfaces of the insulating base that face each other in a thickness direction. JP 2019-96592 A discloses that the insulating base has a through hole (hole) extending through the insulating base in the thickness direction.

### SUMMARY

When the insulating film is used for the electrode assembly, the heat dissipation performance of the electrode assembly decreases because the insulating film has low thermal conductivity. When the insulating film is used for the electrode assembly, it is desirable to increase the heat dissipation performance of the electrode assembly.

The present disclosure has been made in view of the above problem, and has an object to provide an electrode assembly in which the heat dissipation performance of the electrode assembly is improved when an insulating film is used for the electrode assembly.
(1) An electrode assembly according to an aspect of the present disclosure is an electrode assembly including a laminated sheet including a first electrode sheet, a separator, and a second electrode sheet. The laminated sheet is wound around a winding axis. The first electrode sheet includes: a current collecting layer including an insulating film and a conductive film provided on a surface of the insulating film; and an active material layer provided on a main surface of the conductive film that is located opposite to a side where the insulating film is located across the conductive film. A region of the current collecting layer where the active material layer is laminated has a plurality of holes extending through the current collecting layer. Each of the holes includes a high thermal conductivity portion. The high thermal conductivity portion is made of a material having a thermal conductivity higher than a thermal conductivity of the insulating film. In a wound state in which the first electrode sheet is wound around the winding axis, the first electrode sheet includes a first portion that is located on an outermost side and serves as one turn around the winding axis, a second portion that is located inward of the first portion and serves as one turn around the winding axis, and a third portion that is located inward of the second portion and serves as one turn around the winding axis. The holes include a first hole provided in the first portion, a second hole provided in the second portion, and a third hole provided in the third portion. When a portion of the second portion that faces the first hole in a direction perpendicular to a surface of the first portion is defined as a first facing portion, the second hole is located away from the first facing portion. When a portion of the third portion that faces the second hole in a direction perpendicular to a surface of the second portion is defined as a second facing portion, the third hole is located away from the second facing portion.
(2) In the electrode assembly according to (1), the high thermal conductivity portion is provided by at least one of the conductive film that covers an inner peripheral surface that defines each of the holes and the active material layer that covers the inner peripheral surface.
(3) In the electrode assembly according to (1), each of the holes is provided such that a length in a direction in which the winding axis extends is larger than a length in a direction perpendicular to the winding axis.
(4) The electrode assembly according to (1) includes a flat region and a curved region in the wound state. A density of the holes is higher in the curved region than in the flat region.
(5) The electrode assembly according to (1) includes a flat region and a curved region in the wound state. A density of the holes is higher in the flat region than in the curved region.
(6) The electrode assembly according to (1) includes an end located on one side in a direction in which the winding axis extends. The current collecting layer includes an end side located at the end. The current collecting layer includes a protruding piece that is provided on the end side and protrudes in the direction in which the winding axis extends. The protruding piece includes a root located close to the end side, and a tip extending from the root in the direction in which the winding axis extends. The protruding piece has two or more holes extending through the protruding piece. A density of the two or more holes is lower in the root than in the tip.
(7) The electrode assembly according to (1) includes an end located on one side in a direction in which the winding axis extends. The current collecting layer includes an end side located at the end. The current collecting layer includes a protruding piece that is provided on the end side and protrudes in the direction in which the winding axis extends. The protruding piece includes a root located close to the end side, and a tip extending from the root in the direction in which the winding axis extends. The protruding piece has two or more holes extending through the protruding piece. A density of the two or more holes is lower in the tip than in the root.

According to the present disclosure, when the insulating film is used for the electrode assembly, it is possible to increase the heat dissipation performance of the electrode assembly.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing a power storage cell including an electrode assembly according to an embodiment;

FIG. 2 is a perspective view of an electrode assembly 10 shown in FIG. 1;

FIG. 3 is a sectional view taken along line III-III in FIG. 2;

FIG. 4 is an enlarged perspective view of a portion of a first electrode sheet 1;

FIG. 5 is a developed plan view of a current collecting layer 110;

FIG. 6 is an enlarged plan view of a protruding piece T1 shown in FIG. 5;

FIG. 7 is an enlarged plan view of a protruding piece of an electrode assembly in a first modification; and

FIG. 8 is a developed plan view of a current collecting layer of a first electrode sheet of an electrode assembly in a second modification.

### DETAILED DESCRIPTION OF EMBODIMENTS

An embodiment and modifications of the present disclosure will be described in detail below with reference to the drawings. The same or corresponding portions are denoted by the same signs throughout the drawings, and description thereof will not be repeated.

### Embodiment

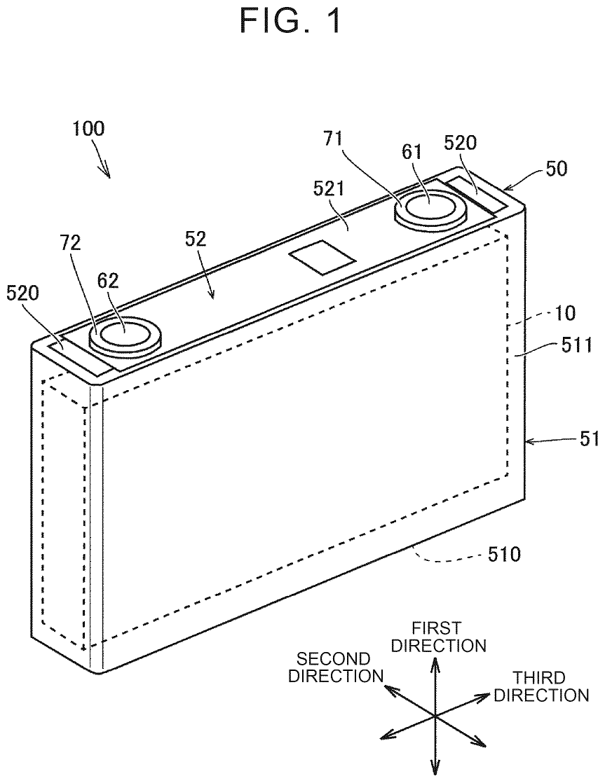

FIG. 1 is a perspective view showing a power storage cell including an electrode assembly according to the present embodiment. A power storage cell 100 is a so-called prismatic battery. The power storage cell 100 is a secondary battery that is chargeable and dischargeable. The power storage cell 100 may be a secondary battery such as a lithium ion battery or a nickel metal hydride battery. The power storage cell 100 can be used, for example, as a cell in a power storage module mounted on an electrified vehicle.

The power storage cell 100 includes an electrode assembly 10, a case 50, a first external terminal 61, a second external terminal 62, a first terminal support portion 71, and a second terminal support portion 72. FIG. 1 schematically shows the electrode assembly 10.

The case 50 is conductive. A conductive portion of the case 50 is made of a metal such as aluminum. The case 50 houses the electrode assembly 10. The case 50 contains an electrolyte solution (not shown).

The case 50 includes a case body 51 and a lid 52. The case body 51 includes a bottom wall 510 and a peripheral wall 511 standing from the bottom wall 510. The bottom wall 510 and the lid 52 are disposed away from each other in a first direction. The first direction corresponds to the vertical direction. The first direction, a second direction, and a third direction shown in FIG. 1 are orthogonal to each other. The first direction, the second direction, and the third direction only need to intersect each other, and need not be orthogonal to each other.

The lid 52 includes a lid body 520 and an insulating cover 521. The lid body 520 is joined to the peripheral wall 511 by welding etc. to close an opening of the peripheral wall 511.

The first external terminal 61 and the second external terminal 62 are disposed away from each other in the third direction. The first external terminal 61 and the second external terminal 62 are exposed to the outside of the power storage cell 100. The first external terminal 61 is a positive terminal, and the second external terminal 62 is a negative terminal.

The first terminal support portion 71 engages with the lid body 520. The first terminal support portion 71 supports the first external terminal 61 from the outer periphery of the first external terminal 61. The second terminal support portion 72 engages with the lid body 520. The second terminal support portion 72 supports the second external terminal 62 from the outer periphery of the second external terminal 62.

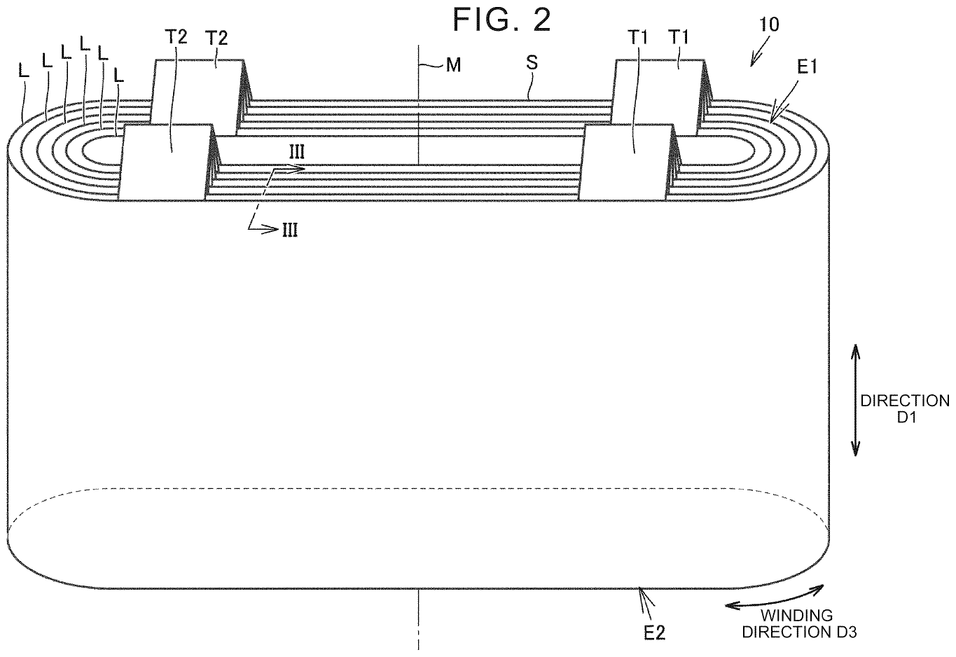

FIG. 2 is a perspective view of the electrode assembly 10 shown in FIG. 1. The electrode assembly 10 is a wound electrode assembly in which a laminated sheet S is wound around a winding axis M. A direction D1 in which the winding axis M extends is substantially parallel to the first direction shown in FIG. 1. The laminated sheet S includes a plurality of portions L each serving as one turn around the winding axis M, a plurality of protruding pieces T1, and a plurality of protruding pieces T2. First current collecting tabs (not shown) are joined to the protruding pieces T1, and second current collecting tabs (not shown) are joined to the protruding pieces T2. The first current collecting tab is electrically connected to the first external terminal 61 (see FIG. 1) by a first connecting member (not shown). The second current collecting tab is electrically connected to the second external terminal 62 (see FIG. 1) by a second connecting member (not shown).

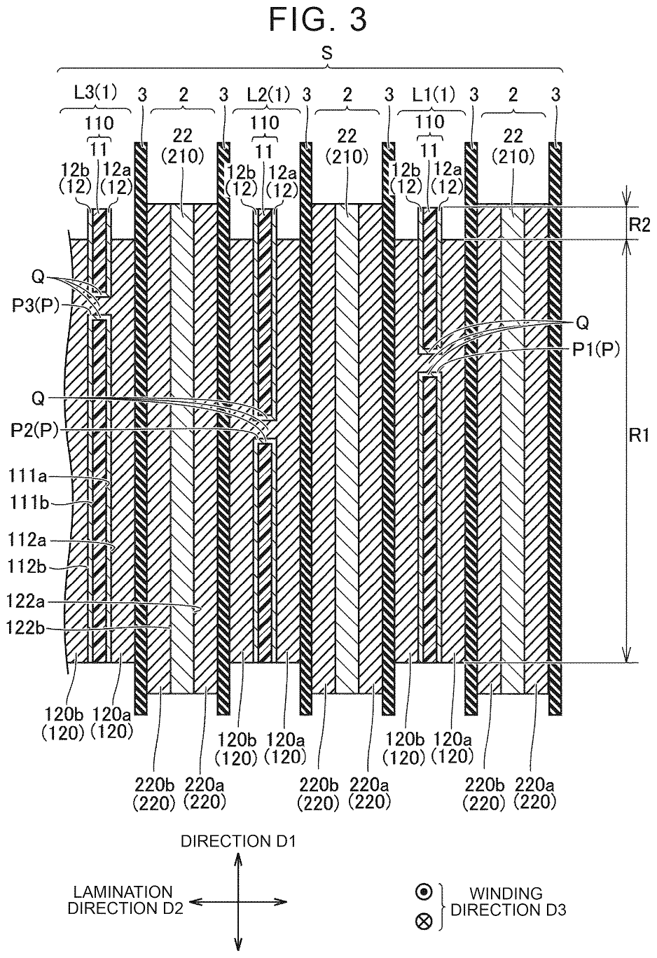

FIG. 3 is a sectional view taken along line III-III in FIG. 2. In FIG. 3, the protruding pieces T1 are omitted. The laminated sheet S includes a first electrode sheet 1, a separator 3, and a second electrode sheet 2. The first electrode sheet 1, the separator 3, and the second electrode sheet 2 are laminated in a lamination direction D2 and wound around the winding axis M (see FIG. 2). The electrode assembly 10 may be a laminated electrode assembly in which the first electrode sheet 1, the separator 3, and the second electrode sheet 2 are laminated in the lamination direction D2.

The first electrode sheet 1 is a cathode. The first electrode sheet 1 includes a current collecting layer 110 and two active material layers 120. The current collecting layer 110 includes an insulating film 11 and two conductive films 12.

The insulating film 11 is made of an electrically insulating resin composition. For example, the insulating film 11 is made of a resin composition containing a polyester resin. The polyester resin is preferably, for example, polyethylene terephthalate. This can increase the rigidity of the current collecting layer 110 while maintaining the electrical insulation properties of the insulating film 11. Furthermore, the insulating film 11 can be made relatively thin. The insulating film 11 includes a surface 111a and a surface 111b disposed away from each other in the lamination direction D2. Each of the surface 111a and the surface 111b is a surface along a winding direction D3. The surface 111b is located closer to the winding axis M than the surface 111a.

Each of the two conductive films 12 is a metal layer. Each conductive film 12 is made of a metal containing aluminum. Therefore, the current collecting layer 110 can be suitably used as a cathode current collector. The two conductive films 12 include a conductive film 12a and a conductive film 12b. The conductive film 12a is provided on the surface 111a of the insulating film 11. The conductive film 12b is provided on the surface 111b of the insulating film 11. The conductive film 12a and the conductive film 12b are vapor-deposited on the insulating film 11.

The current collecting layer 110 includes a region R1 where the active material layers 120 are laminated and a region R2 where the active material layers 120 are not laminated.

The two active material layers 120 include an active material layer 120a and an active material layer 120b. The active material layer 120a is provided on a main surface 112a of the conductive film 12a that is located opposite to the side where the insulating film 11 is located across the conductive film 12a. The active material layer 120b is provided on a main surface 112b of the conductive film 12b that is located opposite to the side where the insulating film 11 is located across the conductive film 12b. The main surface 112a and the main surface 112b correspond to two main surfaces of the current collecting layer 110 that are disposed away from each other in the lamination direction D2. The main surface 112a and the main surface 112b are surfaces along the winding direction D3. The active material layer 120a is applied to the conductive film 12a, and the active material layer 120b is applied to the conductive film 12b.

The second electrode sheet 2 is an anode. The second electrode sheet 2 includes a current collecting layer 210 and two active material layers 220. The current collecting layer 210 includes a conductive film 22. The conductive film 22 is a metal layer. The conductive film 22 is made of a metal containing copper. Therefore, the current collecting layer 210 can be suitably used as an anode current collector. The conductive film 22 includes a main surface 122a and a main surface 122b disposed away from each other in the lamination direction D2. The main surface 122a and the main surface 122b correspond to two main surfaces of the current collecting layer 210 that are disposed away from each other in the lamination direction D2. The main surface 122a and the main surface 122b are surfaces along the winding direction D3.

The two active material layers 220 include an active material layer 220a and an active material layer 220b. The active material layer 220a is provided on the main surface 122a. The active material layer 220b is provided on the main surface 122b. The active material layer 220a and the active material layer 220b are applied to the conductive film 22.

The separator 3 is provided between the first electrode sheet 1 and the second electrode sheet 2. The separator 3 separates the first electrode sheet 1 from the second electrode sheet 2 while allowing ions to travel between the first electrode sheet 1 and the second electrode sheet 2. The ions are, for example, lithium ions. The separator 3 is electrically insulating.

The region R1 of the current collecting layer 110 where the active material layers 120 are laminated has a plurality of holes P extending through the current collecting layer 110 in the lamination direction D2. A high thermal conductivity portion Q is formed in each of the holes P. The high thermal conductivity portion Q is made of a material having a thermal conductivity higher than the thermal conductivity of the insulating film 11. In the present embodiment, the high thermal conductivity portion Q is formed by the conductive film 12 that covers an inner peripheral surface that defines each of the holes P and the active material layer 120 that fills the hole P.

The high thermal conductivity portion Q may be formed by the conductive film 12 that covers the inner peripheral surface that defines each of the holes P, and the active material layer 120 need not fill the hole P. The high thermal conductivity portion Q may be formed by the active material layer 120 that covers the inner peripheral surface that defines each of the holes P and the active material layer 120 that fills the hole P. The high thermal conductivity portion Q may be formed by the active material layer 120 that covers the inner peripheral surface that defines each of the holes P, and the active material layer 120 need not fill the hole P. The high thermal conductivity portion Q may be formed by the conductive film 12 that covers the inner peripheral surface that defines each of the holes P and the active material layer 120 that covers the inner peripheral surface.

In a wound state in which the first electrode sheet 1 is wound around the winding axis M, the first electrode sheet 1 includes a first portion L1 that is located on the outermost side and serves as one turn around the winding axis M, a second portion L2 that is located inward of the first portion L1 and serves as one turn around the winding axis M, and a third portion L3 that is located inward of the second portion L2 and serves as one turn around the winding axis M. The holes P include a first hole P1 formed in the first portion L1, a second hole P2 formed in the second portion L2, and a third hole P3 formed in the third portion L3.

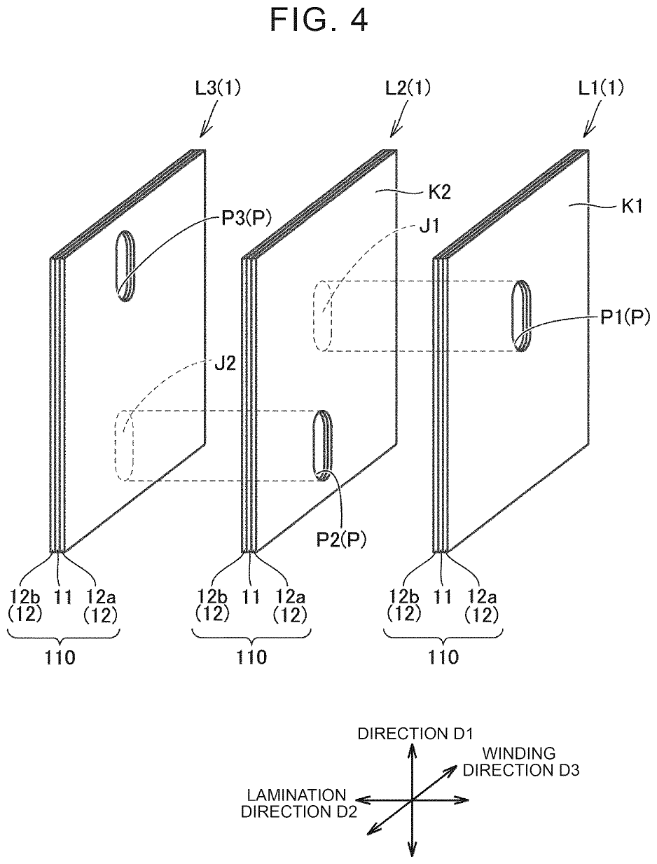

FIG. 4 is an enlarged perspective view of a portion of the first electrode sheet 1. For clarity of the drawing, the active material layers 120 are omitted from FIG. 4. When a portion of the second portion L2 that faces the first hole P1 in a direction perpendicular to a surface K1 of the first portion L1 is defined as a first facing portion J1, the second hole P2 is located away from the first facing portion J1. The surface K1 is a surface of the first portion L1 along the winding direction D3. The direction perpendicular to the surface K1 corresponds to the lamination direction D2.

When a portion of the third portion L3 that faces the second hole P2 in a direction perpendicular to a surface K2 of the second portion L2 is defined as a second facing portion J2, the third hole P3 is located away from the second facing portion J2. The surface K2 is a surface of the second portion L2 along the winding direction D3. The direction perpendicular to the surface K2 corresponds to the lamination direction D2.

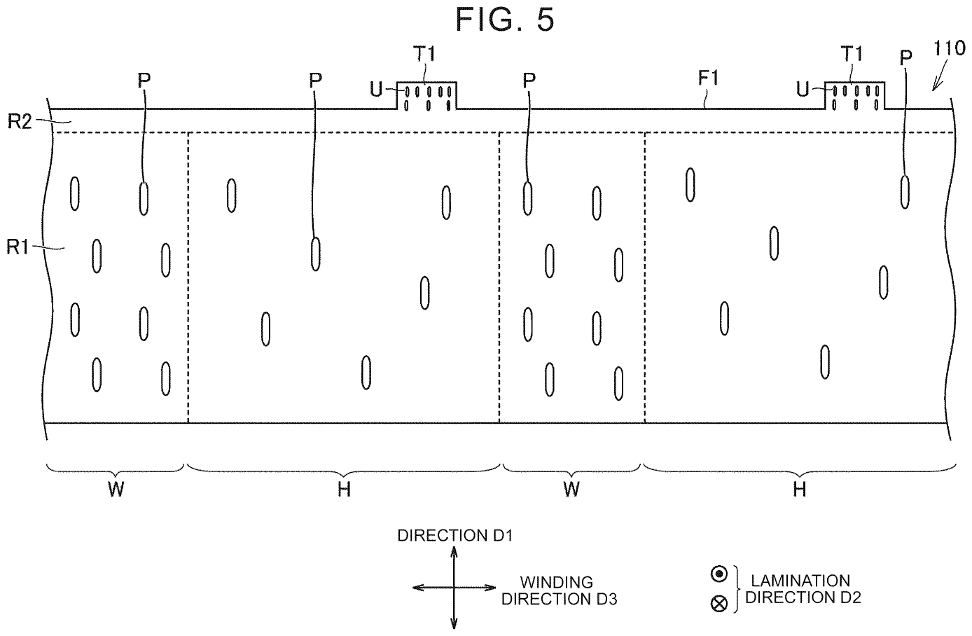

FIG. 5 is a developed plan view of the current collecting layer 110. Each of the holes P is formed such that the length in the direction D1 in which the winding axis M extends is larger than the length in a direction perpendicular to the winding axis M (see FIG. 2). Each hole P may be formed such that the length in the direction D1 in which the winding axis M extends is equal to the length in the direction perpendicular to the winding axis M. Each hole P may be formed such that the length in the direction perpendicular to the winding axis M is larger than the length in the direction D1 in which the winding axis M extends.

The electrode assembly 10 (specifically, the current collecting layer 110) includes flat regions H and curved regions W in the wound state. The density of the holes P is higher in the curved region W than in the flat region H. The density of the holes P may be the same in the curved region W and the flat region H.

Referring again to FIG. 2, the electrode assembly 10 includes an end E1 and an end E2 disposed away from each other in the direction D1 in which the winding axis M extends. The end E1 is an end of the electrode assembly 10 that is located on one side in the direction D1 in which the winding axis M extends. Referring again to FIG. 5, the current collecting layer 110 includes an end side F1 located at the end E1 (see FIG. 2). The current collecting layer 110 includes the protruding pieces T1 that are formed on the end side F1 and protrude in the direction D1 in which the winding axis M extends. The protruding piece T1 is formed in the region R2 where the active material layers 120 are not laminated.

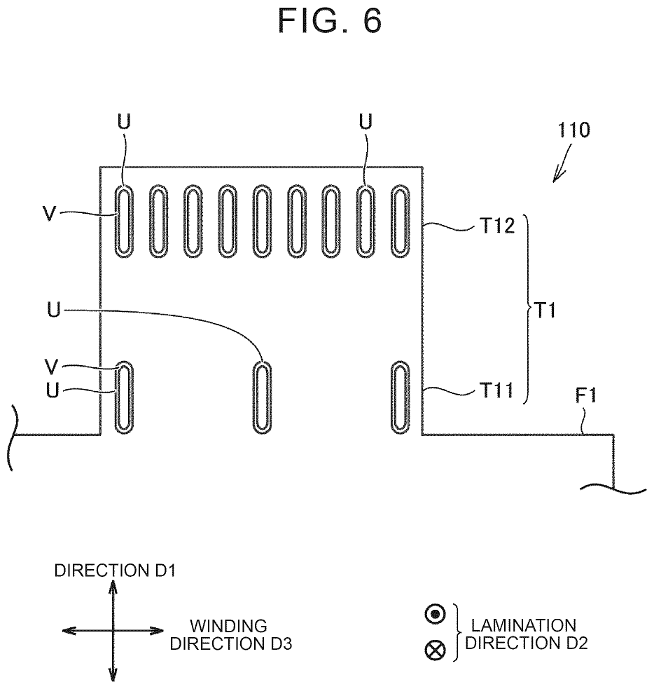

FIG. 6 is an enlarged plan view of the protruding piece T1 shown in FIG. 5. The protruding piece T1 includes a root T11 located close to the end side F1, and a tip T12 extending from the root T11 in the direction D1 in which the winding axis M extends. The first current collecting tab (not shown) is joined to the tip T12. Two or more holes U are formed in the protruding piece T1. Each of the two or more holes U extends through the protruding piece T1 of the current collecting layer 110 in the lamination direction D2. Each hole U is formed such that the length in the direction D1 in which the winding axis M extends is larger than the length in a direction perpendicular to the winding axis M (see FIG. 2). Each hole U may be formed such that the length in the direction D1 in which the winding axis M extends is equal to the length in the direction perpendicular to the winding axis M. Each hole U may be formed such that the length in the direction perpendicular to the winding axis M is larger than the length in the direction D1 in which the winding axis M extends.

A conductive portion V is formed in each of the two or more holes U. The conductive portion V is formed by the conductive film 12 (see FIG. 3) that covers an inner peripheral surface that defines the hole U. The density of the two or more holes U is lower in the root T11 than in the tip T12.

As described above, in the present embodiment, the holes P extending through the current collecting layer 110 are formed in the current collecting layer 110. The high thermal conductivity portion Q is formed in each hole P. In general, when the insulating film is used for the electrode assembly, the heat dissipation performance of the current collecting layer including the insulating film and the conductive film decreases because the insulating film has low thermal conductivity. In the present embodiment, the holes P including the high thermal conductivity portions Q are formed in the current collecting layer 110. Therefore, the heat dissipation performance of the electrode assembly 10 can be increased.

In general, when several holes are arranged in a row, the heat dissipation performance of the electrode assembly at the location where the several holes are arranged in a row is higher than the heat dissipation performance of the other locations on the electrode assembly. Therefore, temperature unevenness occurs on the surface of the electrode assembly (surface along the winding direction of the electrode sheet). When temperature unevenness occurs on the surface of the electrode assembly, heat transfer occurs between a high-temperature location and a low-temperature location on the surface of the electrode assembly, which may cause a decrease in the heat dissipation performance of the electrode assembly.

In the present embodiment, as described with reference to FIG. 4, the second hole P2 is located away from the first facing portion J1, and the third hole P3 is located away from the second facing portion J2. In the present embodiment, the holes P are not arranged in a row in the first portion L1 located on the outermost side of the first electrode sheet 1, the second portion L2 located inward of the first portion L1, and the third portion L3 located inward of the second portion L2. This can suppress the occurrence of temperature unevenness on the surface of the electrode assembly 10. Therefore, according to the present embodiment, heat can be efficiently dissipated from the surface of the electrode assembly 10. Thus, according to the present embodiment, when the insulating film is used for the electrode assembly, it is possible to increase the heat dissipation performance of the electrode assembly.

In the present embodiment, the high thermal conductivity portion Q is formed by at least one of the conductive film 12 that covers the inner peripheral surface that defines each of the holes P and the active material layer 120 that covers the inner peripheral surface. When the conductive film 12 is vapor-deposited on the insulating film 11, the conductive film 12 easily adheres to the inner peripheral surface that defines the hole P. When the active material layer 120 is applied to the conductive film 12, the active material layer 120 easily adheres to the inner peripheral surface that defines the hole P. Therefore, according to the present embodiment, the high thermal conductivity portion Q can be easily formed in the hole P. When the high thermal conductivity portion Q is formed by the conductive film 12 that covers the inner peripheral surface that defines each of the holes P, the conductivity of the electrode assembly 10 can be improved because the inner peripheral surface is covered by the conductive film 12.

In the present embodiment, each of the holes P is formed such that the length in the direction D1 in which the winding axis M extends is larger than the length in the direction perpendicular to the winding axis M. In general, in the electrode assembly, a current is collected in the direction in which the winding axis extends. Therefore, according to the present embodiment, an increase in current collection resistance can be suppressed.

In the present embodiment, the density of the holes P is higher in the curved region W than in the flat region H. Thus, the electrode assembly 10 can be easily bent in the curved region W.

In the present embodiment, the two or more holes U are formed in the protruding piece T1. Therefore, the heat dissipation performance of the protruding piece T1 is improved. In the present embodiment, the density of the two or more holes U is lower in the root T11 than in the tip T12. Current collection paths are concentrated at the root T11. Therefore, a decrease in current collection efficiency can be suppressed by reducing the density of the holes U in the root T11. As described above, the first current collecting tab is joined to the tip T12. By forming the conductive portion V in each hole U, it is possible to reduce the electrical resistance at the joint between the tip T12 and the first current collecting tab.

### First Modification

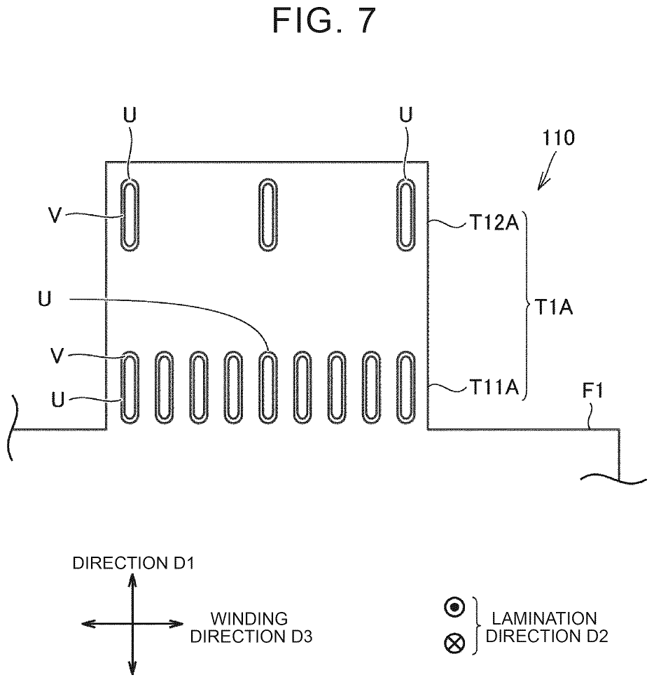

FIG. 7 is an enlarged plan view of a protruding piece of an electrode assembly in a first modification. The electrode assembly in the first modification differs from the electrode assembly 10 in the above embodiment in terms of the protruding piece of the current collecting layer 110. In other respects, the electrode assembly in the first modification is the same as the electrode assembly 10 in the above embodiment.

The electrode assembly in the first modification includes a protruding piece T1A as the protruding piece of the current collecting layer 110 instead of the protruding piece T1 (see FIG. 6). Specifically, in the first modification, the current collecting layer 110 includes the protruding piece T1A that is formed on the end side F1 and protrudes in the direction D1 in which the winding axis M extends. The protruding piece T1A is formed in the region R2 where the active material layers 120 are not laminated (see FIG. 5). The protruding piece T1A includes a root T11A located close to the end side F1, and a tip T12A extending from the root T11A in the direction D1 in which the winding axis M extends. The first current collecting tab (not shown) is joined to the tip T12A. The two or more holes U are formed in the protruding piece T1A. Each of the two or more holes U extends through the protruding piece T1A of the current collecting layer 110 in the lamination direction D2. The conductive portion V is formed in each of the two or more holes U. The conductive portion V is formed by the conductive film 12 (see FIG. 3) that covers the inner peripheral surface that defines the hole U. The density of the two or more holes U is lower in the tip T12A than in the root T11A. In other respects, the protruding piece T1A in the first modification is the same as the protruding piece T1 in the above embodiment.

As described above, in the first modification, the two or more holes U are formed in the protruding piece T1A. Therefore, the heat dissipation performance of the protruding piece T1A is improved. In the electrode assembly of the first modification, the density of the two or more holes U is lower in the tip T12A than in the root T11A. As described above, the first current collecting tab is joined to the tip T12A. By reducing the density of the holes U in the tip T12A, it is possible to reduce the electrical resistance at the joint between the tip T12A and the first current collecting tab. Current collection paths are concentrated at the root T11A. A decrease in current collection efficiency can be suppressed by forming the conductive portion V in each hole U.

### Second Modification

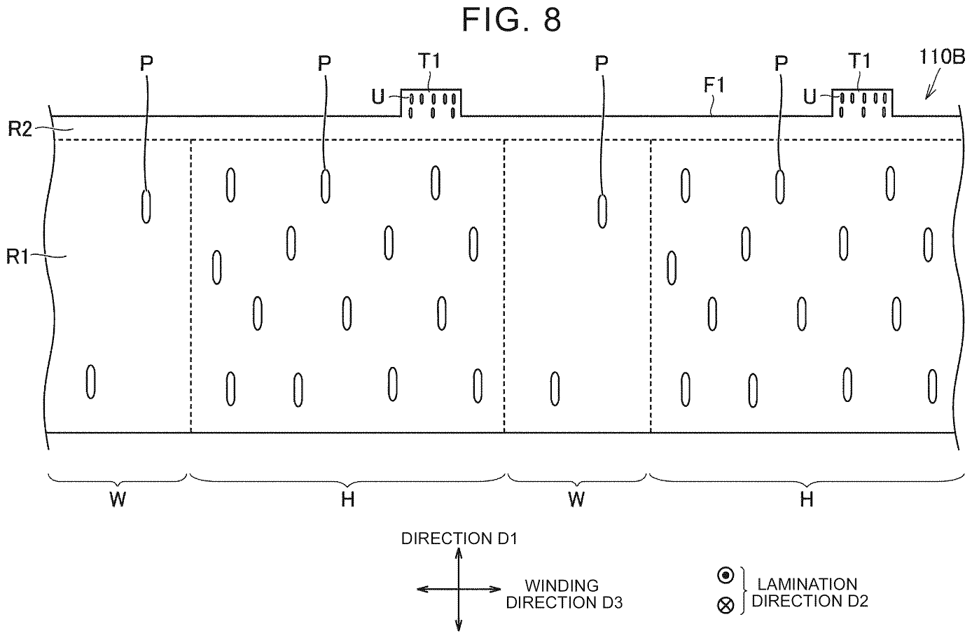

FIG. 8 is a developed plan view of a current collecting layer of a first electrode sheet of an electrode assembly in a second modification. The electrode assembly in the second modification differs from the electrode assembly 10 in the above embodiment in terms of the current collecting layer of the first electrode sheet. In other respects, the electrode assembly in the second modification is the same as the electrode assembly 10 in the above embodiment.

Specifically, the electrode assembly in the second modification includes a current collecting layer 110B as the current collecting layer of the first electrode sheet 1 (see FIG. 3) instead of the current collecting layer 110 (see FIG. 5). The region R1 of the current collecting layer 110B where the active material layers 120 are laminated (see FIG. 3) has the holes P extending through the current collecting layer 110B in the lamination direction D2. The electrode assembly (specifically, the current collecting layer 110B) in the second modification includes the flat regions H and the curved regions W in the wound state. The current collecting layer 110B differs from the current collecting layer 110 in terms of the density of the holes P in the curved region W and the density of the holes P in the flat region H. In the second modification, the density of the holes P is higher in the flat region H than in the curved region W. In other respects, the current collecting layer 110B in the second modification is the same as the current collecting layer 110 in the above embodiment.

As described above, in the second modification, the density of the holes P is higher in the flat region H than in the curved region W. In general, the flat region H is often closer to the case 50 (see FIG. 1) than the curved region W. Therefore, the heat dissipation performance of the flat region H is often lower than the heat dissipation performance of the curved region W. In the second modification, the density of the holes P is higher in the flat region H than in the curved region W. Therefore, according to the second modification, the heat dissipation performance of the flat region H can be improved.

The embodiment and modifications disclosed herein should be considered to be illustrative in all respects and not restrictive. The scope of the present disclosure is defined by the claims rather than by the above description, and is intended to include all modifications within the meaning and scope equivalent to those of the claims.

What is claimed is:

1. An electrode assembly comprising a laminated sheet including a first electrode sheet, a separator, and a second electrode sheet, the laminated sheet being wound around a winding axis, wherein
the first electrode sheet includes:
a current collecting layer including an insulating film and a conductive film provided on a surface of the insulating film; and
an active material layer provided on a main surface of the conductive film that is located opposite to a side where the insulating film is located across the conductive film,
a region of the current collecting layer where the active material layer is laminated has a plurality of holes extending through the current collecting layer,
each of the holes includes a high thermal conductivity portion,
the high thermal conductivity portion is made of a material having a thermal conductivity higher than a thermal conductivity of the insulating film,
in a wound state in which the first electrode sheet is wound around the winding axis, the first electrode sheet includes a first portion that is located on an outermost side and serves as one turn around the winding axis, a second portion that is located inward of the first portion and serves as one turn around the winding axis, and a third portion that is located inward of the second portion and serves as one turn around the winding axis,
the holes include a first hole provided in the first portion, a second hole provided in the second portion, and a third hole provided in the third portion,
when a portion of the second portion that faces the first hole in a direction perpendicular to a surface of the first portion is defined as a first facing portion, the second hole is located away from the first facing portion, and
when a portion of the third portion that faces the second hole in a direction perpendicular to a surface of the second portion is defined as a second facing portion, the third hole is located away from the second facing portion.

2. The electrode assembly according to claim 1, wherein the high thermal conductivity portion is provided by at least one of the conductive film that covers an inner peripheral surface that defines each of the holes and the active material layer that covers the inner peripheral surface.

3. The electrode assembly according to claim 1, wherein each of the holes is provided such that a length in a direction in which the winding axis extends is larger than a length in a direction perpendicular to the winding axis.

4. The electrode assembly according to claim 1, wherein:
the electrode assembly includes a flat region and a curved region in the wound state; and
a density of the holes is higher in the curved region than in the flat region.

5. The electrode assembly according to claim 1, wherein:
the electrode assembly includes a flat region and a curved region in the wound state; and
a density of the holes is higher in the flat region than in the curved region.

6. The electrode assembly according to claim 1, wherein:
the electrode assembly includes an end located on one side in a direction in which the winding axis extends;
the current collecting layer includes an end side located at the end;
the current collecting layer includes a protruding piece that is provided on the end side and protrudes in the direction in which the winding axis extends;
the protruding piece includes a root located close to the end side, and a tip extending from the root in the direction in which the winding axis extends;
the protruding piece has two or more holes extending through the protruding piece; and
a density of the two or more holes is lower in the root than in the tip.

7. The electrode assembly according to claim 1, wherein:
the electrode assembly includes an end located on one side in a direction in which the winding axis extends;
the current collecting layer includes an end side located at the end;
the current collecting layer includes a protruding piece that is provided on the end side and protrudes in the direction in which the winding axis extends;
the protruding piece includes a root located close to the end side, and a tip extending from the root in the direction in which the winding axis extends;
the protruding piece has two or more holes extending through the protruding piece; and
a density of the two or more holes is lower in the tip than in the root.
